(19) United States
(12) Patent Application Publication
(10) Pub. No.: US 2026/0133383 A1
(43) Pub. Date: May 14, 2026

(54) HYBRID INTEGRATED OPTOELECTRONIC DEVICE

(71) Applicant: SHINKO ELECTRIC INDUSTRIES CO., LTD., Nagano (JP)

(72) Inventors: Honoka SHIMA, Nagano (JP); Hisashi KANEDA, Nagano (JP); Yuji FURUTA, Nagano (JP)

(21) Appl. No.: 19/386,922

(22) Filed: Nov. 12, 2025

(30) Foreign Application Priority Data
Nov. 14, 2024 (JP) 2024-198875

(51) Int. Cl. G02B 6/42

(52) U.S. Cl. CPC G02B 6/4214

(57) ABSTRACT

A hybrid integrated optoelectronic device includes an interconnect substrate including an insulating layer and an interconnect layer disposed at a position corresponding to an upper surface of the insulating layer, and a stepped surface recessed relative to the upper surface, a photonic integrated circuit including one or more first electrodes and arranged on the stepped surface with the one or more first electrodes facing upward, an optical component arranged on the stepped surface adjacent to the photonic integrated circuit, and configured to exchange an optical signal with the photonic integrated circuit, and a semiconductor device having second electrodes and arranged on the upper surface with the second electrodes facing downward, wherein some of the second electrodes are bonded to the interconnect layer, and a rest of the second electrodes are bonded to the one or more first electrodes.

### CROSS-REFERENCE TO RELATED APPLICATIONS

The present application is based on and claims priority to Japanese Patent Application No. 2024-198875 filed on Nov. 14, 2024, with the Japanese Patent Office, the entire contents of which are incorporated herein by reference.

### FIELD

The disclosures herein relate to hybrid integrated optoelectronic devices.

### BACKGROUND

Optical connection structures for connecting optical waveguide devices to optical fibers or the like may be used in data centers or the like where various computers and data communication devices are installed. As an example of such optical connection structures, an optical connection component using a planar lightwave circuit is fixedly bonded to the end face of an input/output waveguide of an optical waveguide device, and that optical waveguide device and an optical fiber are optically connected via the planar lightwave circuit (See, for example, Patent Document 1).

In the optical connection structure as described above, the optical waveguide device and the optical connection component are fixedly bonded with a small adhesion area, which results in a weak adhesion strength. As a result, applying stress to the connection between the optical waveguide device and the optical connection component poses a risk of connection breakage, and the connection reliability cannot be said to be high.

Accordingly, there may be a need for a hybrid integrated optoelectronic device having an optical connection structure with high connection reliability.

### RELATED ART DOCUMENT

### Patent Document

[Patent Document 1] Japanese Laid-Open Patent Publication No. 2020-64211

### SUMMARY

According to an aspect of the embodiment, a hybrid integrated optoelectronic device includes an interconnect substrate including an insulating layer and an interconnect layer disposed at a position corresponding to an upper surface of the insulating layer, and a stepped surface recessed relative to the upper surface, a photonic integrated circuit including one or more first electrodes and arranged on the stepped surface with the one or more first electrodes facing upward, an optical component arranged on the stepped surface adjacent to the photonic integrated circuit, and configured to exchange an optical signal with the photonic integrated circuit, and a semiconductor device having second electrodes and arranged on the upper surface with the second electrodes facing downward, wherein some of the second electrodes are bonded to the interconnect layer, and a rest of the second electrodes are bonded to the one or more first electrodes.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating an example of a hybrid integrated optoelectronic device according to a first embodiment;

FIG. 2 is a cross-sectional view illustrating the example of the hybrid integrated optoelectronic device according to the first embodiment;

FIG. 3 is a cross-sectional view illustrating an example of a hybrid integrated optoelectronic device according to a first variation of the first embodiment;

FIG. 4 is a cross-sectional view illustrating an example of the hybrid integrated optoelectronic device with an attached fiber array; and

FIG. 5 is a cross-sectional view illustrating an example of a hybrid integrated optoelectronic device according to a second variation of the first embodiment.

### DESCRIPTION OF EMBODIMENTS

Embodiments of the invention will be described below with reference to the accompanying drawings. In these drawings, the same components are denoted by the same reference numerals, and duplicate descriptions may be omitted.

### First Embodiment

### [Structure of Hybrid Integrated Optoelectronic Device]

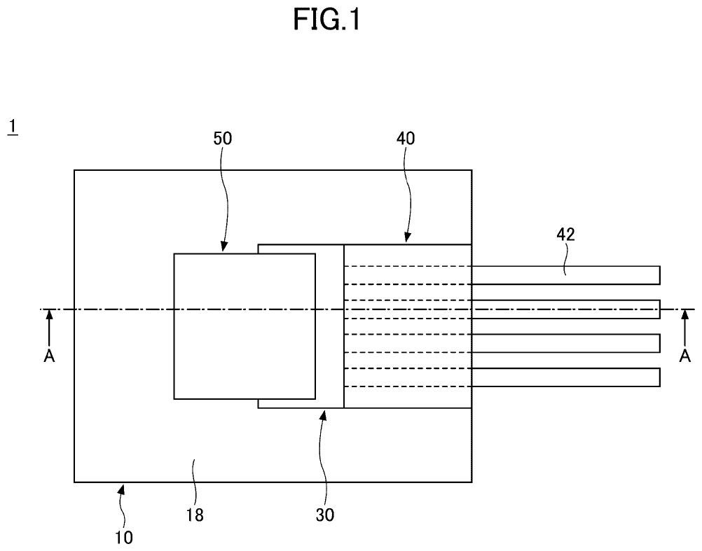

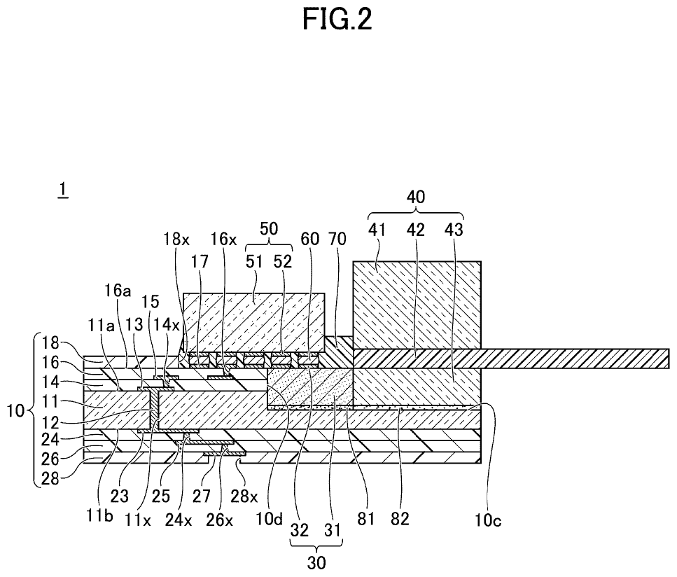

FIG. 1 is a plan view illustrating an example of a hybrid integrated optoelectronic device according to a first embodiment. FIG. 2 is a cross-sectional view illustrating the example of the hybrid integrated optoelectronic device according to the first embodiment, and illustrates a cross-section taken along the line A-A in FIG. 1.

Referring to FIGS. 1 and 2, a hybrid integrated optoelectronic device 1 includes an interconnect substrate 10, a photonic integrated circuit 30, a fiber array 40, and a semiconductor device 50. The hybrid integrated optoelectronic device 1 may further include bonding members 60 and a resin portion 70. The fiber array 40 is a representative example of an optical component according to the present invention.

The interconnect substrate 10 includes a core layer 11 having a first surface 11a and a second surface 11b opposite the first surface 11a. The interconnect substrate 10 includes an interconnect layer 13, an insulating layer 14, an interconnect layer 15, an insulating layer 16, an interconnect layer 17, and a solder resist layer 18 which are sequentially laminated on the first surface 11a of the core layer 11. The interconnect substrate 10 also includes an interconnect layer 23, an insulating layer 24, an interconnect layer 25, an insulating layer 26, an interconnect layer 27, and a solder resist layer 28 which are sequentially laminated on the second surface 11b of the core layer 11.

In the hybrid integrated optoelectronic device 1 of the first embodiment, for convenience, the solder resist layer 18 side of the interconnect substrate 10 is referred to as an upper side or a first side, and the solder resist layer 28 side is referred to as a lower side or a second side. The surface of a portion oriented in the same direction as the solder resist layer 18 side is referred to as a first surface or an upper surface, and the surface of the portion oriented in the same direction as the solder resist layer 28 side is referred to as a second surface or a lower surface. Nonetheless, the hybrid integrated optoelectronic device 1 may be positioned upside down when used, or may be arranged at any angle. The plan view refers to the view of an object as seen from the direction normal to the first surface Ila of the core layer 11, and the plan shape refers to the shape of an object as seen from the direction normal to the first surface 11a of the core layer 11.

The core layer 11 is provided, for example, at the center of the interconnect substrate 10 in the thickness direction. The core layer 11 is formed, for example, as a flat plate. The plan shape of the core layer 11 may be any shape. The plan shape of the core layer 11 may be, for example, rectangular.

The core layer 11 is preferably an insulating layer having a higher rigidity than the insulating layers laminated on the first surface 11a and the second surface 11b. The core layer 11 is formed thicker than the insulating layers laminated on the first surface 11a and the second surface 11b, for example. The thickness of the core layer 11 may be, for example, in the range of approximately 50 μm to 500 μm.

The material of the core layer 11 is preferably a material having a thermal expansion coefficient close to the thermal expansion coefficient of the photonic integrated circuit 30, the thermal expansion coefficient of the fiber array 40, and the thermal expansion coefficient of the semiconductor device 50. The material of the core layer 11 may be, for example, glass or silicon. The core layer 11 is formed as, for example, a single layer. That is, the core layer 11 has a single seamless structure.

The core layer 11 has through holes 11x (only one of which is illustrated) that extend through the core layer 11 in the thickness direction. The plan shape of each of the through holes 11x is, for example, circular.

The interconnect layer 13 is disposed on the first surface 11a of the core layer 11. The interconnect layer 23 is disposed on the second surface 11b of the core layer 11. The interconnect layer 13 and the interconnect layer 23 are electrically connected to each other by through interconnects 12 formed in the through holes 11x. Each of the interconnect layers 13 and 23 is patterned in a predetermined plan shape. The interconnect layers 13 and 23 and the through interconnect 12 may be made of, for example, copper (Cu) or the like. The thicknesses of the interconnect layers 13 and 23 are, for example, in the range of approximately 5 to 20 μm. The interconnect layer 13, the interconnect layer 23, and the through interconnect 12 may be seamlessly formed.

The insulating layer 14 is an interlayer insulating layer disposed on the first surface 11a of the core layer 11 and covering the interconnect layer 13. The material of the insulating layer 14 may be an insulating resin or the like mainly composed of, for example, an epoxy-based resin or a polyimide-based resin. The thickness of the insulating layer 14 may be, for example, in the range of approximately 10 to 30 μm. The insulating layer 14 may contain a filler such as silica (SiO₂).

Via holes 14x (only one of which is illustrated) are formed in the insulating layer 14 to extend through the insulating layer 14 and reach the upper surface of the interconnect layer 13. The via holes 14x may each be an inverted truncated conical hole for which the diameter of the opening toward the insulating layer 16 is larger than the diameter of the opening at the upper surface of the interconnect layer 13.

The interconnect layer 15 is formed on the first side of the insulating layer 14. The interconnect layer 15 includes via interconnects filling the via holes 14x and an interconnect pattern formed on the upper surface of the insulating layer 14. The interconnect pattern is electrically connected to the interconnect layer 13 through the via interconnects. The material of the interconnect layer 15 and the thickness of the interconnect pattern may be substantially the same as those of the interconnect layer 13, for example.

The insulating layer 16 is formed on the upper surface of the insulating layer 14 so as to cover the interconnect layer 15. The material and the thickness of the insulating layer 16 may be substantially the same as those of the insulating layer 14, for example. The insulating layer 16 may contain a filler such as silica (SiO₂).

Via holes 16x (only one of which is illustrated) are formed in the insulating layer 16 to extend through the insulating layer 16 and reach the upper surface of the interconnect layer 15. The via holes 16x may each be an inverted truncated conical hole for which the diameter of the opening toward the solder resist layer 18 is larger than the diameter of the opening at the upper surface of the interconnect layer 15.

The interconnect layer 17 is disposed at a position corresponding to the upper surface 16a of the insulating layer 16. The interconnect layer 17 may include via interconnects filling the via holes 16x and pads formed on the upper surface 16a of the insulating layer 16. The pads may be electrically connected to the interconnect layer 15 through the via interconnects. The material of the interconnect layer 17 and the thickness of the pads may be substantially the same as those of the interconnect layer 13, for example. The thickness of the pads may be larger than that of the interconnect layer 13. Further, the interconnect layer 17 may include an interconnect pattern in addition to the pads. The pads and the interconnect pattern constituting the interconnect layer 17 may be provided on the upper surface 16a of the insulating layer 16, for example. Alternatively, the pads and the interconnect pattern constituting the interconnect layer 17 may be provided such that the lower surfaces and the side surfaces thereof are embedded in the insulating layer 16 and the upper surfaces thereof are flush with the upper surface 16a of the insulating layer 16.

The solder resist layer 18 is a protective insulating layer located as the outermost layer on the first side of the interconnect substrate 10, and is formed on the upper surface 16a of the insulating layer 16. The solder resist layer 18 has an opening 18x, and the interconnect layer 17 is located within the opening 18x. The interconnect layer 17 located in the opening 18x may be used for electrical connections with an electronic component such as a semiconductor chip, for example. The solder resist layer 18 may be formed of, for example, photosensitive epoxy-based insulating resin or acrylic-based insulating resin. The thickness of the solder resist layer 18 is, for example, in the range of approximately 15 to 35 μm.

On the surface of the interconnect layer 17 located in the opening 18x, a metal layer may be formed, or an organic coating may be formed by applying an antioxidant treatment such as organic solderability preservative (OSP) treatment. Examples of the metal layer include an Au layer, a Ni/Au layer (a metal layer made by laminating a Ni layer and an Au layer in this order), a Ni/Pd/Au layer (a metal layer made by laminating a Ni layer, a Pd layer, and an Au layer in this order), and a Sn layer.

The insulating layer 24 is an interlayer insulating layer disposed on the second surface 11b of the core layer 11 and covering the interconnect layer 23. The material and thickness of the insulating layer 24 may be substantially the same as those of the insulating layer 14, for example. The insulating layer 24 may contain a filler such as silica (SiO₂).

Via holes 24x (only one of which are illustrated) are formed in the insulating layer 24 to extend through the insulating layer 24 and reach the lower surface of the interconnect layer 23. The via holes 24x may each be a truncated conical hole for which the diameter of the opening toward the insulating layer 26 is larger than the diameter of the opening at the lower surface of the interconnect layer 23 The interconnect layer 25 is formed on the second side of the insulating layer 24. The interconnect layer 25 includes via interconnects filling the via holes 24x and an interconnect pattern formed on the lower surface of the insulating layer 24. The interconnect pattern is electrically connected to the interconnect layer 23 through the via interconnects. The material and thickness of the interconnect layer 25 may be substantially the same as those of the interconnect layer 13, for example.

The insulating layer 26 is formed on the lower surface of the insulating layer 24 so as to cover the interconnect layer 25. The material and the thickness of the insulating layer 26 may be substantially the same as those of the insulating layer 14, for example. The insulating layer 26 may contain a filler such as silica (SiO₂).

Via holes 26x (only one of which are illustrated) are formed in the insulating layer 26 to extend through the insulating layer 26 and reach the lower surface of the interconnect layer 25. The via holes 26x may each be a truncated conical hole for which the diameter of the opening toward the solder resist layer 28 is larger than the diameter of the opening at the lower surface of the interconnect layer 25.

The interconnect layer 27 is formed on the second side of the insulating layer 26. The interconnect layer 27 includes via interconnects filling the via holes 26x and an interconnect pattern formed on the lower surface of the insulating layer 26. The interconnect pattern is electrically connected to the interconnect layer 25 through the via interconnects. The material and the thickness of the interconnect layer 27 may be substantially the same as those of the interconnect layer 13, for example.

The solder resist layer 28 is a protective insulating layer located as the outermost layer on the second side of the interconnect substrate 10, and is formed on the lower surface of the insulating layer 26. The material and the thickness of the solder resist layer 28 may be substantially the same as those of the solder resist layer 18, for example. The solder resist layer 28 has openings 28x (only one of which is illustrated), and portions of the lower surface of the interconnect layer 27 are exposed within the openings 28x. The plan shape of each of the openings 28x may be, for example, circular. The interconnect layer 27 exposed in the openings 28x may be used as pads for electrical connections to a mounting substrate such as a motherboard. If necessary, a metal layer of the kind previously described may be formed on the lower surface of the interconnect layer 27 exposed in the openings 28x, or an oxidation prevention treatment such as OSP treatment may be applied.

The interconnect substrate 10 is provided with a stepped surface 10c recessed relative to the upper surface 16a of the insulating layer 16. Further, the interconnect substrate 10 has an inner surface 10d connecting the upper surface 16a of the insulating layer 16 and the stepped surface 10c. The upper surface 16a and the stepped surface 10c may be parallel, for example. The stepped surface 10c and the inner surface 10d may be perpendicular, for example.

The stepped surface 10c may be provided at any vertical position recessed relative to the upper surface 16a of the insulating layer 16. In the illustrated example, the stepped surface 10c is located between the first surface 11a and the second surface 11b of the core layer 11, but is not limited to this arrangement. For example, the stepped surface 10c may be provided between the upper surface 16a and the lower surface of the insulating layer 16, between the upper surface and the lower surface of the insulating layer 14, or between the upper surface and the lower surface of another insulating layer. The stepped surface 10c may be formed, for example, by applying pocket milling to the interconnect substrate 10 on which the stepped surface 10c has not been formed.

The photonic integrated circuit (PIC) 30 includes a core 31 and first electrodes 32. The core 31 includes, for example, optical waveguides, light emitting elements, light receiving elements, and the like on a substrate made of silicon or the like. The first electrodes 32 are connection terminals each made of, for example, a gold bump, a solder bump, a copper post with a solder tip, or the like. The first electrodes 32 are disposed on the first side of the core 31. The optical waveguides are disposed on the same side of the core 31 as the first electrodes 32.

The photonic integrated circuit 30 may be referred to as silicon photonics or the like. The photonic integrated circuit 30 may have the function of converting an optical signal input from the fiber array 40 into an electrical signal, and/or the function of converting an electrical signal input from the semiconductor device 50 into an optical signal for output to the fiber array 40.

The photonic integrated circuit 30 is disposed face-up on the stepped surface 10c. That is, the photonic integrated circuit 30 is disposed on the stepped surface 10c with the first electrodes 32 facing upward. The lower surface of the core 31 of the photonic integrated circuit 30 is bonded to the stepped surface 10c via, for example, an adhesive layer 81. The adhesive layer 81 may be, for example, an ultraviolet curable or thermosetting epoxy resin.

The surface on which the first electrodes 32 of the photonic integrated circuit 30 are arranged, that is, the upper surface of the core 31, is preferably flush with the upper surface 16a of the insulating layer 16. This facilitates bonding the second electrodes 52 of the semiconductor device 50 to both the pads of the interconnect layer 17 and the first electrodes 32 of the photonic integrated circuit 30. Th term “flush with” allows for a tolerance of ±5 μm. When the deviation is within this range, adjusting the height of the bonding members 60 facilitates bonding the second electrodes 52 of the semiconductor device 50 to both the pads of the interconnect layer 17 and the first electrodes 32 of the photonic integrated circuit 30.

The fiber array 40 is disposed adjacent to the photonic integrated circuit 30 on the stepped surface 10c. The fiber array 40 includes, for example, a base 41, a plurality of optical fibers 42, and a lid 43. In the illustrated example, 4 optical fibers 42 are arranged side by side at predetermined intervals. Each of the optical fibers 42 extends to the outside of the interconnect substrate 10 across one side of the stepped surface 10c in plan view.

The base 41 and the lid 43 hold each of the optical fibers 42 therebetween. The surface of the base 41 facing the lid 43 is provided with, for example, a plurality of grooves for arranging the optical fibers 42, and each optical fiber 42 is arranged in a different groove. The surface of the lid 43 facing the base 41 is, for example, a flat plane without grooves. The base 41 and the lid 43 may be formed of, for example, glass.

The fiber array 40 is arranged with the lid 43 facing toward the stepped surface 10c. The lower surface of the lid 43 is bonded to the stepped surface 10c via, for example, an adhesive layer 82. The adhesive layer 82 may be, for example, an ultraviolet curable or thermosetting epoxy resin. The end of each optical fiber 42 faces the end of a corresponding optical waveguide of the photonic integrated circuit 30. With this arrangement, each optical waveguide of the photonic integrated circuit 30 may exchange an optical signal with a corresponding optical fiber 42.

The thickness of the lid 43 is preferably equal to or less than the thickness of the core 31 of the photonic integrated circuit 30. This facilitates the arrangement by active alignment in which the ends of the optical fibers 42 and the ends of the optical waveguides of the photonic integrated circuit 30 face each other. The gap between the lower surface of the lid 43 and the stepped surface 10c may be filled by adjusting the amount of the adhesive layer 82. The thickness of the lid 43 may be equal to the thickness of the core 31 of the photonic integrated circuit 30.

The semiconductor device 50 includes a core 51 with a semiconductor integrated circuit, and a plurality of second electrodes 52 serving as connection terminals. The second electrodes 52 are disposed on the first side of the core 51. The core 51 is mainly made of silicon, for example. The second electrodes 52 are, for example, gold bumps, solder bumps, copper posts with solder tips, or the like. The semiconductor device 50 is disposed face-down on the upper surface 16a of the insulating layer 16. That is, the semiconductor device 50 is disposed on the upper surface 16a with the second electrodes 52 facing downward.

Some of the second electrodes 52 of the semiconductor device 50 are bonded to the pads of the interconnect layer 17 of the interconnect substrate 10 through the conductive bonding members 60 such as solder. The rest of the second electrodes 52 of the semiconductor device 50 are bonded to the first electrodes 32 of the photonic integrated circuit 30 through the conductive bonding members 60 such as solder. This arrangement enables the supply of power from the semiconductor device 50 to the photonic integrated circuit 30 and the exchange of electrical signals between the semiconductor device 50 and the photonic integrated circuit 30. Upon receiving power from the semiconductor device 50, the photonic integrated circuit 30 can transmit and receive optical signals.

The semiconductor device 50 has, for example, the function of amplifying an electrical signal input from the photonic integrated circuit 30. Electrical signals input from the photonic integrated circuit 30 are high-speed signals and thus easily attenuated. Connecting the photonic integrated circuit 30 and the semiconductor device 50 via short paths through the bonding members 60 and amplifying the attenuating electrical signals in the semiconductor device 50 effectively improves the quality of the electrical signals output from the semiconductor device 50.

The resin portion 70 is located on the upper surface 16a of the insulating layer 16. The resin portion 70 is disposed at least around the bonding members 60 between the lower surface of the semiconductor device 50 and the upper surface 16a of the insulating layer 16 and around the bonding members 60 between the lower surface of the semiconductor device 50 and the upper surface of the photonic integrated circuit 30. This arrangement effectively improves the connection reliability between the second electrodes 52 of the semiconductor device 50 and the interconnect layer 17. In addition, the connection reliability between the second electrodes 52 of the semiconductor device 50 and the first electrodes 32 of the photonic integrated circuit 30 is effectively improved. The resin portion 70 may be disposed between the opposing surfaces of the fiber array 40 and the semiconductor device 50. When there is a gap between the photonic integrated circuit 30 and the fiber array 40 or the like on the stepped surface 10c, the resin portion 70 may be disposed in the gap. The material of the resin portion 70 preferably has good fluidity because of the need to infiltrate into a narrow space. For example, an insulating resin such as an epoxy-based resin may be used as the material of the resin portion 70.

In order to fabricate the hybrid integrated optoelectronic device 1, first, an interconnect substrate 10 is prepared that has at least an insulating layer 16 and an interconnect layer 17 exposed on the upper surface 16a of the insulating layer 16 and a stepped surface 10c recessed from the upper surface 16a. Next, a photonic integrated circuit 30 is fixed to the stepped surface 10c with the first electrodes 32 facing upward. Next, a semiconductor device 50 is mounted on the upper surface 16a of the insulating layer 16 with the second electrodes 52 facing downward. In doing so, conductive bonding members 60 are used to bond some of the second electrodes 52 of the semiconductor device 50 to the interconnect layer 17, and the rest of the second electrodes 52 are bonded to the first electrodes 32 of the photonic integrated circuit 30.

Upon the completion of this process, the supply of power from the semiconductor device 50 to the photonic integrated circuit 30 and the exchange of electrical signals between the semiconductor device 50 and the photonic integrated circuit 30 become possible, and the photonic integrated circuit 30 receiving power from the semiconductor device 50 is able to transmit and receive optical signals. While light is being transmitted from the photonic integrated circuit 30, the fiber array 40 is arranged adjacent to the photonic integrated circuit 30 on the stepped surface 10c to perform active alignment. Thereafter, while the photonic integrated circuit 30 and the fiber array 40 are aligned, the fiber array 40 is fixed to the stepped surface 10c. Subsequently, the resin portion 70 is disposed as necessary.

As described above, the hybrid integrated optoelectronic device 1 is such that the connection between the photonic integrated circuit 30 and the fiber array 40 is located on the stepped surface 10c. As a result, unlike a conventional structure in which the connection between the two members is located outside the substrate in plan view, stress is unlikely to be concentrated on the connection between the photonic integrated circuit 30 and the fiber array 40. This arrangement effectively reduces the likelihood of breakage at the connection between the photonic integrated circuit 30 and the fiber array 40. That is, an optical connection structure with high connection reliability is effectively formed between the photonic integrated circuit 30 and the fiber array 40.

Further, the hybrid integrated optoelectronic device 1 is such that the interconnect substrate 10 has the stepped surface 10c, and the photonic integrated circuit 30 and the fiber array 40 are arranged on the stepped surface 10c, which effectively facilitates reduction in the height of the hybrid integrated optoelectronic device 1.

Further, the hybrid integrated optoelectronic device 1 is configured such that the photonic integrated circuit 30 is arranged face-up on the stepped surface 10c, thereby positioning the optical waveguides of the photonic integrated circuit 30 near the upper surface 16a of the insulating layer 16. This arrangement facilitates alignment between the optical waveguides of the photonic integrated circuit 30 and the optical fibers 42 of the fiber array 40.

### First Variation of First Embodiment

A first variation of the first embodiment is directed to an example in which a connector is arranged in place of the fiber array.

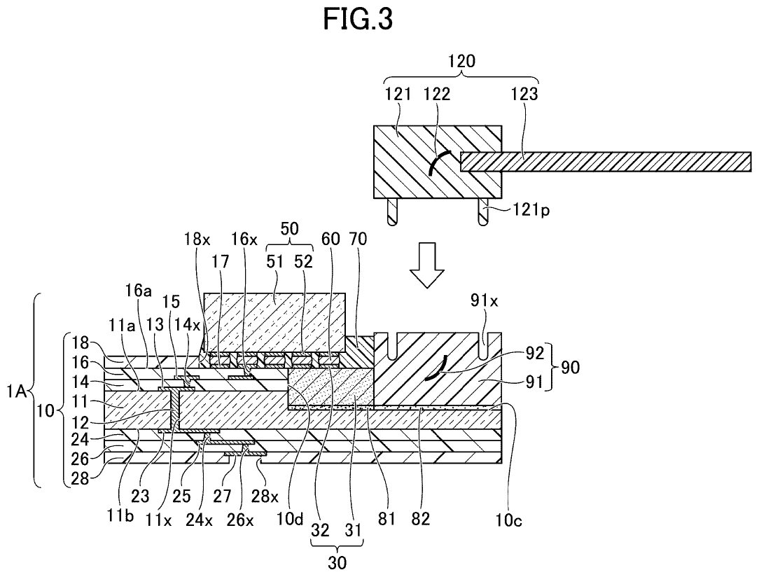

FIG. 3 is a cross-sectional view illustrating an example of a hybrid integrated optoelectronic device according to the first variation of the first embodiment. Referring to FIG. 3, a hybrid integrated optoelectronic device 1A differs from the hybrid integrated optoelectronic device 1 in that a connector 90 is provided in place of the fiber array 40. The connector 90 is a typical example of an optical component according to the present invention, and is connectable to a fiber array having optical fibers.

The connector 90 is disposed on the stepped surface 10c adjacent to the photonic integrated circuit 30 via the adhesive layer 82. The connector 90 includes, for example, a housing 91 and a reflecting member 92. The housing 91 is made of a material transparent at the wavelength of incident light. The reflecting member 92 has the function of changing the direction of incident light. The reflecting member 92 is, for example, a concave mirror capable of bending the direction of incident light by 90 degrees. A plurality of positioning recesses 91x are formed in the upper surface of the housing 91.

The connector 90 is configured to allow the detachable attachment of a fiber array 120. The fiber array 120 is attached and detached along the direction perpendicular to the stepped surface 10c. The fiber array 120 includes, for example, a housing 121, a reflecting member 122, and a plurality of optical fibers 123. The housing 121 is made of a material transparent at the wavelength of incident light and serves as a connector. The reflecting member 122 has the function of changing the direction of incident light. The reflecting member 122 is, for example, a concave mirror capable of bending the direction of incident light by 90 degrees. A plurality of protrusions 121p for positioning purposes are formed on the lower surface of the housing 121.

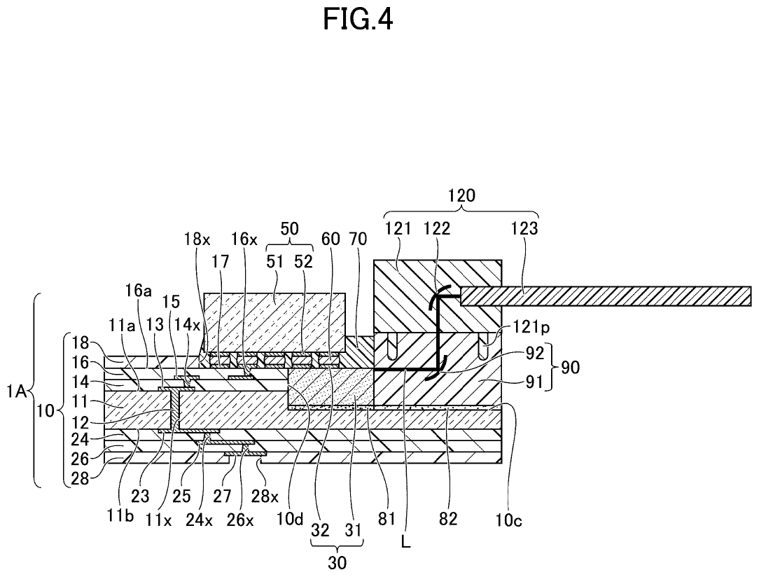

FIG. 4 is a cross-sectional view illustrating an example of the hybrid integrated optoelectronic device IA with the fiber array 120 attached thereto. As illustrated in FIG. 4, the protrusions 121p of the housing 121 engages in the recesses 91x of the housing 91, thereby positioning the connector 90 and the fiber array 120. In this state, for example, light L transmitted from the photonic integrated circuit 30 changes its direction at the reflecting member 92 of the connector 90 and reaches the reflecting member 122 of the fiber array 120. The light L reaching the reflecting member 122 changes its direction at the reflecting member 122, enters the optical fiber 123, and travels through the optical fiber 123. This arrangement effectively substantially the same configuration as that of the hybrid integrated optoelectronic device 1 illustrated in FIGS. 1 and 2. That is, the connector 90 is connectable to the fiber array 120 having the optical fibers 123, and connecting the connector 90 to the fiber array 120 effectively enables the exchange of optical signals between the photonic integrated circuit 30 and the optical fibers 123.

As described above, the optical component according to the present invention is not limited to the fiber array, but may be a connector as long as it is disposed adjacent to the photonic integrated circuit 30 on the stepped surface 10c and contributes to the exchange of optical signals with the photonic integrated circuit 30.

When the optical component according to the present invention is the connector 90, stress may be repeatedly applied to the connection between the connector 90 and the photonic integrated circuit 30 when the fiber array 120 is attached to and detached from the connector 90. Therefore, arranging the connection between the photonic integrated circuit 30 and the connector 90 on the stepped surface 10c offers significant technical advantages, inasmuch as the stress applied to the connection between the photonic integrated circuit 30 and the connector 90 is reduced.

### Second Variation of First Embodiment

The second variation of the first embodiment is directed to an example in which a connector different in type from that of the first variation of the first embodiment is used.

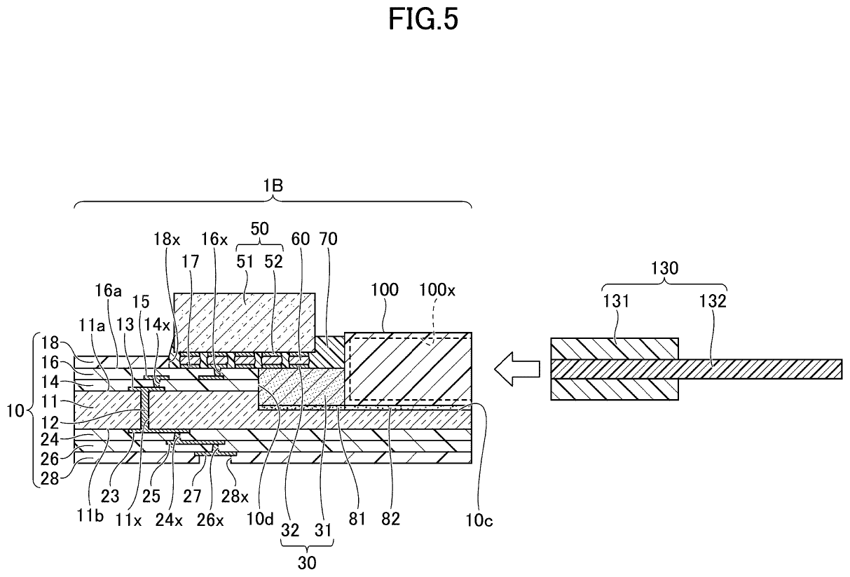

FIG. 5 is a cross-sectional view illustrating an example of a hybrid integrated optoelectronic device according to the second variation of the first embodiment. Referring to FIG. 5, a hybrid integrated optoelectronic device 1B differs from the hybrid integrated optoelectronic device IA in that the hybrid integrated optoelectronic device 1B includes a connector 100 instead of the connector 90. The connector 100 is a typical example of an optical component according to the present invention and is connectable to a fiber array with optical fibers.

The connector 100 is disposed on the stepped surface 10c adjacent to the photonic integrated circuit 30 through the adhesive layer 82. The connector 100 is a female connector and has an insertion portion 100x opening on the side opposite the photonic integrated circuit 30. The connector 100 is made of a material transparent at the wavelength of incident light. Alternatively, the connector 100 may be made of a material opaque at the wavelength of incident light, and an opening that allows the exchange of an optical signal may be provided in a region facing each optical waveguide of the photonic integrated circuit 30.

The connector 100 is configured to allow the detachable attachment of a fiber array 130. The fiber array 130 is attached and detached along a direction parallel to the stepped surface 10c. The fiber array 130 includes, for example, a housing 131 and a plurality of optical fibers 132. The housing 131 of the fiber array 130 is inserted into the insertion portion 100x of the connector 100. That is, the connector 100 is connectable to the fiber array 130 having the optical fibers 132, and connecting the connector 100 to the fiber array 130 effectively enables the exchange of optical signals between the photonic integrated circuit 30 and the optical fibers 132.

As described above, the direction in which the fiber array is attached to and detached from the connector disposed adjacent to the photonic integrated circuit 30 may be perpendicular to the stepped surface 10c or parallel to the stepped surface 10c.

According to at least one embodiment, a hybrid integrated optoelectronic device having an optical connection structure with high connection reliability is effectively provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. A hybrid integrated optoelectronic device comprising:
an interconnect substrate including an insulating layer and an interconnect layer disposed at a position corresponding to an upper surface of the insulating layer, and a stepped surface recessed relative to the upper surface;
a photonic integrated circuit including one or more first electrodes and arranged on the stepped surface with the one or more first electrodes facing upward;
an optical component arranged on the stepped surface adjacent to the photonic integrated circuit, and configured to exchange an optical signal with the photonic integrated circuit; and
a semiconductor device having second electrodes and arranged on the upper surface with the second electrodes facing downward,
wherein some of the second electrodes are bonded to the interconnect layer, and a rest of the second electrodes are bonded to the one or more first electrodes.

2. The hybrid integrated optoelectronic device according to claim 1, wherein a surface of the photonic integrated circuit at which the one or more first electrodes are provided is flush with the upper surface.

3. The hybrid integrated optoelectronic device according to claim 1, wherein the optical component is a fiber array including a plurality of optical fibers, and the photonic integrated circuit is configured to exchange optical signals with the optical fibers.

4. The hybrid integrated optoelectronic device according to claim 3, wherein the fiber array includes a base and a lid configured to hold the optical fibers therebetween, and is disposed with the lid facing toward the stepped surface, and
wherein a thickness of the lid is less than or equal to a thickness of the photonic integrated circuit.

5. The hybrid integrated optoelectronic device according to claim 1, wherein the optical component is a connector connectable to a fiber array including optical fibers, and connecting the connector to the fiber array allows the photonic integrated circuit to exchange optical signals with the optical fibers.

6. The hybrid integrated optoelectronic device according to claim 5, wherein the connector includes a reflecting member configured to change a direction of incident light.

7. The hybrid integrated optoelectronic device according to claim 1, wherein the photonic integrated circuit has at least one of:
a function of converting an optical signal input from the optical component into an electrical signal for output to the semiconductor device; or
a function of converting an electrical signal input from the semiconductor device into an optical signal for output to the optical component.

8. The hybrid integrated optoelectronic device according to claim 1, wherein the semiconductor device has a function of amplifying an electrical signal input from the photonic integrated circuit.
